(19) United States
(12) Patent Application Publication
(10) Pub. No.: US 2012/0104860 A1
(43) Pub. Date: May 3, 2012

(54) POWER SUPPLY DEVICE FOR NETWORK ATTACHED STORAGE

(75) Inventors: LAN-YI FENG, Shenzhen (CN); YA-JUN PAN, Shenzhen (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/975,266

(22) Filed: Dec. 21, 2010

(30) Foreign Application Priority Data
Oct. 28, 2010 (CN) 201010523221.9

(51) Int. Cl. H02J 1/00

(52) U.S. Cl. 307/80

(57) ABSTRACT

A power supply device for a network attached storage (NAS) is connected to both a power over Ethernet (POE) system and a direct current (DC) power supply. A control unit of the power supply device receives a voltage provided by the POE system and a voltage provided by the DC power supply, and compares the two voltages with each other. When the voltage provided by the DC power supply equals or is greater than the voltage provided by the POE system, the control unit inputs electric power of the DC power supply to the NAS and prevents electric power of the POE system from being input to the NAS. When the voltage provided by the DC power supply is less than the voltage provided by the POE system, the control unit allows electric power of the POE system to be input to the NAS.

### BACKGROUND

1. Technical Field

The present disclosure relates to power supply devices, and particularly to a power supply device for network attached storages (NAS).

2. Description of Related Art

Network attached storages (NAS) are widely used. For the most part, direct current (DC) power supplies and power over Ethernet (POE) systems are often used to power the NAS. Since the POE systems are also used to transmit data to the NAS, the DC power supplies are generally used to provide the NAS with electric power prior to the POE systems, thereby decreasing load of the POE systems and conserving electric power. Therefore, when an NAS is electrically connected to both a DC power supply and a POE system, a central processing unit (CPU) of the NAS allows the DC power supply to transmit electric power to the NAS and prohibits the POE system from transmitting electric power to the NAS.

If a NAS being provided with electric power by a POE system is electrically connected to a DC power supply, the CPU of the NAS will immediately prohibit the POE system from transmitting electric power to the NAS upon detecting the DC power supply, so the DC power supply provides electric power to the NAS. However, when the DC power supply is connected to the NAS, it generally needs a response time to generate a voltage that is high enough to normally input electric power of the NAS. Thus, the DC power supply may be unable to normally input electric power to the NAS during the response time, which may cause the NAS to be automatically turned off or even damaged.

Therefore, there is room for improvement within the art.

### BRIEF DESCRIPTION OF THE DRAWINGS

Many aspects of the present power supply device can be better understood with reference to the following drawings. The components in the various drawings are not necessarily drawn to scale, the emphasis instead being placed upon clearly illustrating the principles of the present power supply device. Moreover, in the drawings, like reference numerals designate corresponding parts throughout the figures.

FIG. 1 is a block diagram of a power supply device, according to an exemplary embodiment.

FIG. 2 is a circuit diagram of one exemplary embodiment of the power supply device shown in FIG. 1.

### DETAILED DESCRIPTION

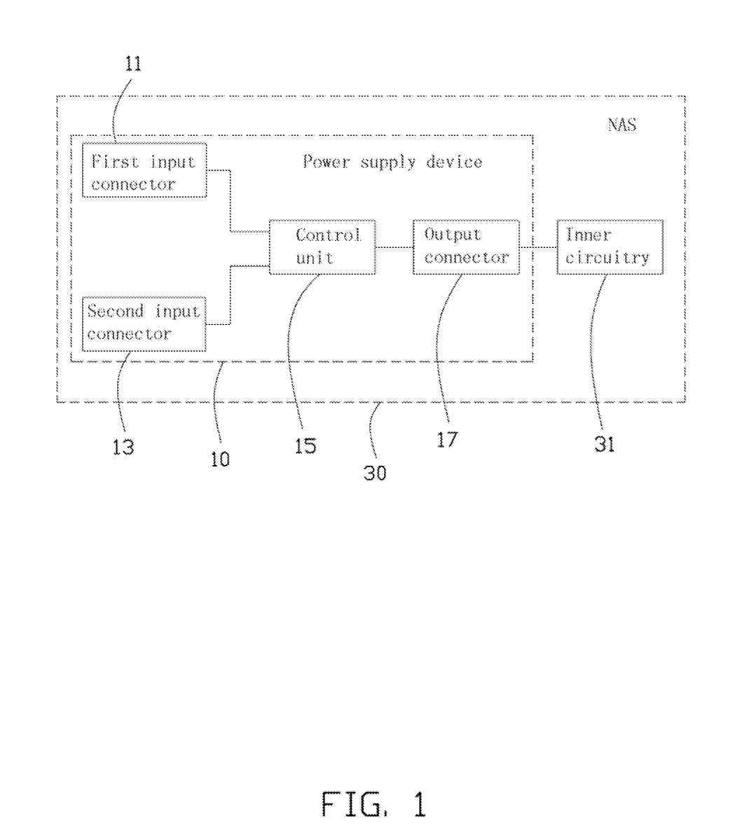

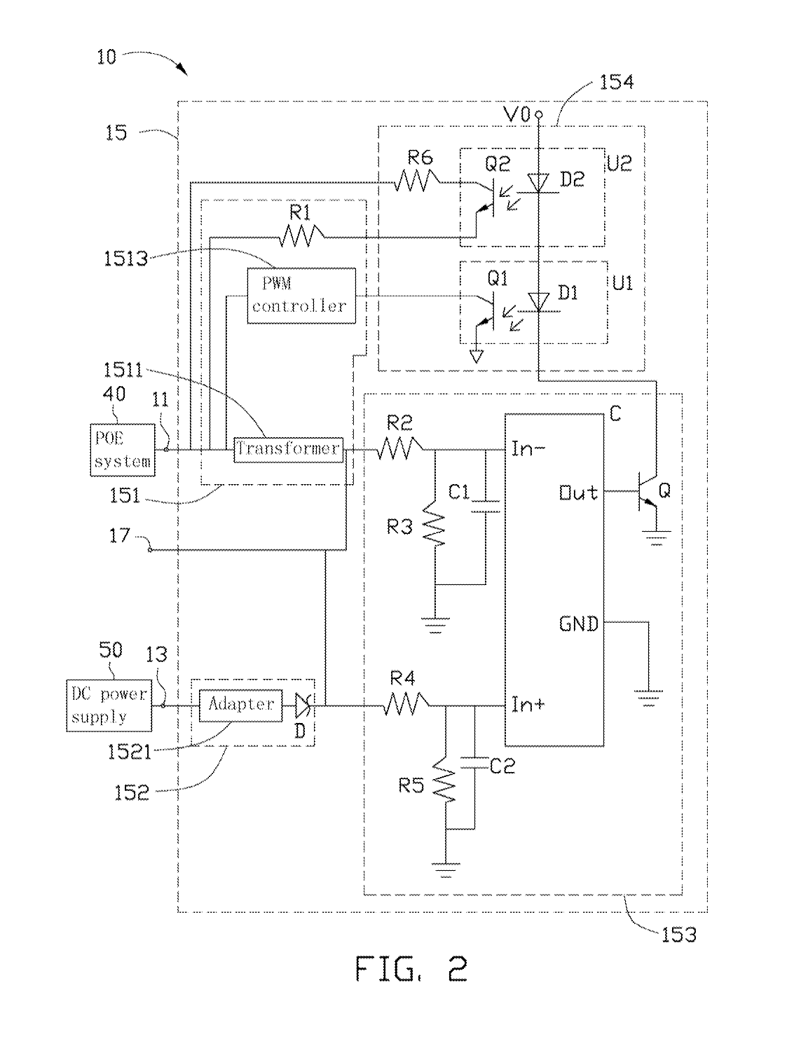

FIG. 1 shows a power supply device 10, according to an exemplary embodiment. The power supply device 10 is installed in a network attached storage (NAS) 30 to provide electric power to the NAS 30. The power supply device 10 includes a first input connector 11, a second input connector 13, a control unit 15, and an output connector 17. The first input connector 11, the second input connector 13, and the output connector 17 are all electrically connected to the control unit 15. The output connector 17 is also electrically connected to inner circuitry 31 of the NAS 30 for inputting electric power to the NAS 30. Also referring to FIG. 2, the first input connector 11 is electrically connected to a power over Ethernet (POE) system 40 to input electric power of the POE system 40 to the power supply device 10. The second input connector 13 is electrically connected to a direct current (DC) power supply 50 to input electric power of the DC power supply 50 to the power supply device 10. The control unit 15 can transmit electric power of the POE system 40 and the DC power supply 50 to the output connector 17 to provide the electric power to the NAS 30.

The control unit 15 includes a first voltage regulating circuit 151, a second voltage regulating circuit 152, a detection circuit 153, and a switch circuit 154. The first voltage regulating circuit 151 is electrically connected to the first input connector 11, the second voltage regulating circuit 152 is electrically connected to the second input connector 13, and both the first voltage regulating circuit 151 and the second voltage regulating circuit 152 are electrically connected to the output connector 17. According to IEEE802.3af standard, the POE system 40 can provide a voltage to the power supply device 10 by the first input connector 11 to input electric power to the power supply device 10. The POE system 40 can automatically maintain the voltage to be in a stable value that is high enough to normally input electric power to the NAS 30, and can stop providing the voltage to the power supply device 10 when detecting that a resistance of the power supply device 10 changes. The first voltage regulating circuit 151 can regulate a voltage provided by the POE system 40 to a predetermined value capable of being used by the NAS 30, and transmit the regulated voltage to the NAS 30 through the output connector 17. When a voltage provided by the DC power supply 50 is high enough to normally input electric power to the NAS 30 (i.e., equals or is greater than the voltage provided by the POE system 40), the second voltage regulating circuit 152 can regulate the voltage provided by the DC power supply 50 to the predetermined value or higher values capable of being used by the NAS 30, and transmit the regulated voltage to the NAS 30 through the output connector 17.

The detection circuit 153 is electrically connected to the first voltage regulating circuit 151, the second regulating circuit 152, and the switch circuit 154. The switch circuit 154 is electrically connected to the first regulating circuit 151 and the detection circuit 153. In use, the detection circuit 153 measures the voltage provided to the output connector 17 by the second voltage regulating circuit 152. If the voltage provided to the output connector 17 by the second voltage regulating circuit 152 achieves the predetermined value used by the inner circuitry 30, the switch circuit 154 prohibits the POE system 40 to input electric power to the NAS 30. If not, the switch circuit 154 allows the POE system 40 to input electric power to the NAS 30.

The first voltage regulating circuit 151 includes a resistor R1, a transformer 1511, and a pulse width modulation (PWM) controller 1513. The resistor R1 has one end connected to the first input connector 11 and another end connected to the switch circuit 154. The PWM controller 1513 has one end connected to the first input connector 11 and another end connected to the switch circuit 154. The transformer 1511 has one end connected to the first input connector 11 and another end connected to both the output connector 17 and the detection circuit 153. The PWM controller 1513 can generate PWM signals to periodically switch the transformer on 1511. Furthermore, the PWM controller 1513 can regulate duty ratio of the PWM signals and switch the transformer 1511 off by regulating the duty ratio of the PWM signals to zero.

The second voltage regulating circuit 152 includes an adapter 1521 and a diode D. The adapter 1521 has one end connected to the second input connector 13 and another end connected to an anode of the diode D. A cathode of the diode D is connected to both the output connector 17 and the detection circuit 153.

The detection circuit 153 includes a comparator C, four resistors R2, R3, R4, R5, two capacitors C1, C2, and a transistor Q. The capacitor C has an inverting input pin IN−, a non-inverting input pin IN+, a ground connector FND, and an output pin Out. The output pin Out outputs a relatively higher electric level when a voltage on the non-inverting input pin IN+ is greater than a voltage on the inverting input pin IN−, and outputs a relatively lower electric level when the voltage on the non-inverting input pin IN+ is less than the voltage on the inverting input pin IN−. The ground pin GND is grounded. The transistor Q has a base connected to the output pin Out, an emitter grounded, and a collector connected to the switch circuit 154. The relatively higher electric level output from the output pin Out can switch the transistor Q on.

The resistor R2 has one end connected to the end of the transformer 1511 that is connected to the output connector 17 and another end connected to the inverting input pin IN−. The resistor R3 and the capacitor C1 are connected in parallel between the end of the resistor R2 connected to the inverting input pin IN− and the ground. The resistor R4 has one end connected to the end of the transformer 1511 that is connected to the output connector 17 and another end connected to the inverting input pin IN−. The resistor R3 and the capacitor C1 are connected in parallel between the end of the resistor R2 connected to the inverting input pin IN− and the ground. Thus, the regulated voltages provided to the output connector 17 by the first voltage regulating circuit 151 and the second voltage regulating circuit 152 are also respectively provide to the resistors R2, R4, and thereby respectively generating input voltages on the inverting input pin IN− and the non-inverting input pin IN+. The resistors R2, R4 can be used for voltage-dividing, and the resistors R3, R5 and the capacitors C1, C2 can be used to filter alternating current (AC) portions of the input voltages. Resistances of the resistors R2, R3, R4, R5 and capacitances of the capacitors C1, C2 are regulated in fabrication to assure that the input voltage generated on the non-inverting input pin IN+ is greater than the input voltage generated on the inverting input pin IN− when the voltage provided to the resistor R4 equals or is greater than the voltage provided to the resistor R2, and is less than the input voltage generated on the inverting input pin IN− when the voltage provided to the resistor R4 is less than the voltage provided to the resistor R2.

The switch circuit 154 includes a first switch U1, a second switch U2, a resistor R6, and a voltage resource V0. The first switch U1 includes a light emitting diode (LED) D1 and a photo transistor Q1 positioned adjacent to the LED D1. The second switch U2 includes an LED D2 and a photo transistor Q2 positioned adjacent to the LED D2. A cathode of the LED D1 is connected to the collector of the transistor Q. An anode of the LED D1 is connected to a cathode of the LED D2. A cathode of the LED D2 is connected to the voltage source V0. A collector of the photo transistor Q1 is connected to the another end of the PWM controller 1513. An emitter of the photo transistor Q2 is connected to the another end of the resistor R1. Light emitted by the LED D1 and D2 can respectively switch the photo transistor Q1 and Q2 on. The resistor R6 has one end connected to a collector of the photo transistor Q2 and another end connected to the first input connector 11.

When the first input connector 11 is connected to the POE system 40, the voltage provided by the POE system 40 is input to the transformer 1511 by the first input connector 11. The transformer 11 regulates the input voltage to the predetermined value capable of being used by the NAS 30, and inputs the regulated voltage to the NAS 30 by the output connector 17 to input electric power of the POE system 40 to the NAS 30. The regulated voltage is also applied to the resistor R2 and generates an input voltage on the inverting input pin IN−. If the DC power supply 50 is not connected to the second input connector 13, there is no voltage on the non-inverting input pin IN+, and the output pin Out outputs a relatively lower electric potential. Thus, the transistor Q is turned off, no current passes through the LED D1, D2, and the photo transistors Q1, Q2 are turned off. The switch circuit 154 does not function, and then the control unit 15 keeps allowing the POE system 40 to transmit electric power to the NAS 30.

When the first input connector 11 and the second input connector 13 are respectively connected to the POE system 40 and the DC power supply 50, as above detailed, the POE system 40 transmits electric power to the NAS 30, and the voltage provided by the POE system 40 is regulated by the transformer 1511 and generates an input voltage on the inverting input pin IN−. At the same time, a voltage provided by the DC power supply 50 is input to the adapter 1521 by the second input connector 13. The adapter 1521 and the diode D regulates the voltage provided by the DC power supply 50, and transmits the regulated voltage to the NAS 30 by the output connector 17. The regulated voltage provided by the second voltage regulating circuit 152 is also applied to the resistor R4 and generates an input voltage on the non-inverting input pin IN+. Thus, the control unit 15 can compares the voltages provided by the POE system 40 and the DC power supply 50 with each other, and prohibit or allow the POE system 40 to input electric power to the NAS 30 according to the comparison result.

Particularly, if the voltage provided by the DC power supply 50 is less than the voltage provided by the POE system 40 (e.g., during a response time of the DC power supply 50 for generating a voltage that is high enough to normally input electric power to the NAS 30), it is not high enough to be regulated to a value capable of being used by the NAS 30 by the second voltage regulating circuit 152. Thus, the regulated voltage provided to the output connector 17 by the second voltage regulating circuit 152 is not high enough to be used by the NAS 30. In such a case, the regulated voltage provided by the second voltage regulating circuit 152 is less than the regulated voltage provided by the first voltage regulating circuit 151 that is capable of being used by the NAS 30. Since the regulated voltage applied to the resistor R4 by the second voltage regulating circuit 152 is less than the regulated voltage applied to the resistor R2 by the first voltage regulating circuit 151, the input voltage generated on the non-inverting input pin IN+ is less than the input voltage generated on the inverting input pin IN−. Thus, the output pin Out still outputs the relatively lower electric potential, the transistor Q, the LED D1, D2, and the photo transistors Q1, Q2 are still turned off, and the control unit 15 keeps allowing the POE system 40 to input electric power to the NAS 30.

If the voltage provided by the DC power supply 50 equals to or is greater than the voltage provided by the POE system 40. The second voltage regulating circuit 152 regulates the voltage provided by the DC power supply 50 to a value that is high enough to be used by the NAS 30, and inputs the regulated voltage to the NAS 30 by the output connector 17 to input electric power of the DC power supply 50 to the NAS 30. Furthermore, the regulated voltage that is provided by the second voltage regulating circuit 152 equals to or is greater than the regulated voltage provided by the first voltage regulating circuit 151. Since the regulated voltage applied to the resistor R4 by the second voltage regulating circuit 152 equals to or is greater than the regulated voltage applied to the resistor R2 by the first voltage regulating circuit 151, the input voltage generated on the non-inverting input pin IN+ is greater than the input voltage generated on the inverting input pin IN−. Thus, the output pin Out outputs the relatively higher electric potential to switch the transistor Q on.

When the transistor Q is switched on, the voltage source V0, the LED D2, the LED D1, the collector and emitter of the transistor Q, and the ground are electronically connected in series. Thus, the switch circuit 154 is switched on. The voltage of the voltage source V0 generates a current passing through the LED D1, D2, and the LED D1, D2 are switched on and emit light. The photo transistors Q1, Q2 are then respectively switched on by light emitted by the LED D1, D2. When the PWM controller 1513 detects that the photo transistor Q1 is switched on, it switches the transformer 1511 off. Thus, the voltage provided by the POE system 40 is prevented from being input to the output connector 17, and the POE system 40 is prohibited to inputting electric power to the NAS 30. In this way, only the DC power supply 50 is used to input electric power to the NAS 30. Additionally, when the photo transistor Q1 is switched on, the resistors R1 and R6 are connected to each other, which changes the resistance of the power supply device 10. The POE system 40 can detect the resistance change of the power supply device 10 through the first input connector 11 and thus stop providing the voltage to the power supply device 10 upon detecting the resistance change. Therefore, the POE system 40 can be prevented from inputting electric power to the NAS 30 by two methods.

The first input connector 11 can also be used to transmit data between the NAS 30 and the POE system 40. When the POE system 40 is prohibited to input electric power to the NAS 30 through the power supply device 10 according to above method, it can still communicate with the NAS 30 through the first input connector 11.

The power supply device 10 can input electric power of the POE system 40 and the DC power supply 50 to the NAS 30. In condition that the POE system 40 and the DC power supply 50 are both connected to the power supply device 10, the control unit 15 can compare the voltages provided by the POE system 40 and the DC power supply 50 with each other, and allow or prohibit the POE system 40 to input electric power to the NAS 30 according to the comparison result. When the DC power supply 50 provides a voltage that is high enough to normally input electric power to the NAS 30 (i.e., equals or is greater than the voltage provided by the POE system 40), the power supply device 10 inputs electric power of the DC power supply 50 to the NAS 30 and prohibits the POE system 40 to input electric power to the NAS 30, thereby decreasing load of the POE system 40. When the DC power supply 50 is unable to provide a voltage that is high enough to normally input electric power to the NAS 30 (i.e., the voltage provided by the DC power supply 50 is less than the voltage provided by the POE system 40), the power supply device 10 allows electric power of the POE system 40 to be input to the NAS 30 to assure that the NAS 30 is provided with a stable power supply voltage.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A power supply device for a network attached storage (NAS), comprising:
a first input connector connected to a power over Ethernet (POE) system;
a second input connector connected to a direct current (DC) power supply;
a control unit connected to both the first input connector and the second input connector; and
an output connector connected to the control unit and the NAS; wherein the control unit receives a voltage provided by the POE system through the first input connector and receives a voltage provided by the DC power supply through the second input connector; wherein when the voltage provided by the DC power supply is greater than or equal to the voltage provided by the POE system, the control unit inputs electric power of the DC power supply to the NAS through the output connector and prevents electric power of the POE system from being input to the NAS; and wherein when the voltage provided by the DC power supply is less than the voltage provided by the POE system, the control unit allows electric power of the POE system to be input to the NAS through the output connector.

2. The power supply device as claimed in claim 1, wherein the control unit includes a first voltage regulating circuit connected to the first input connector and a second voltage regulating circuit connected to the second input connector, both the first voltage regulating circuit and the second voltage regulating circuit connected to the output connector, the first voltage regulating circuit regulating the voltage provided by the POE system to a predetermined value and inputting the regulated voltage to the NAS through the output connector for inputting electric power to the NAS when the control unit allows electric power of the POE system to be input to the NAS, and the second voltage regulating circuit regulating the voltage provided by the DC power supply to the predetermined value or higher values and inputting the regulated voltage to the NAS through the output connector for inputting electric power to the NAS when the voltage provided by the DC power supply equals or is greater than the voltage provided by the POE system.

3. The power supply device as claimed in claim 2, wherein the first voltage regulating circuit includes a transformer and a PWM controller; the transformer connected to the first input connector and the output connector, and transforming the voltage provided by the POE system to the predetermined value; the PWM controller connected to the transformer and controlling the transformer to be switched on/off.

4. The power supply device as claimed in claim 3, wherein the control unit further includes a detection circuit and a switch circuit; the detection circuit connected to the transformer and the second voltage regulating circuit, the switch circuit connected to the PWM controller and the detection circuit; the detection circuit comparing the regulated voltages generated by the first voltage regulating circuit with the second voltage regulating circuit, when the regulated voltage generated by the second voltage regulating circuit equals or is greater than the regulated voltage generated by the first voltage regulating circuit, the detection circuit switching on the switch circuit, and the PWM controller switching the transformer off when detecting that the switching circuit is switched and thereby preventing the POE system from inputting electric power to the NAS.

5. The power supply device as claimed in claim 4, wherein the detection circuit includes a comparator and a transistor; the comparator including an inverting input pin connected to the transformer, a non-inverting input pin connected to the second voltage regulating circuit, and an output pin connected to the transistor; the transistor connected between the switch circuit and ground; when a voltage on the non-inverting input pin is greater than a voltage on the inverting input pin, the comparator switches on the transistor using the output pin.

6. The power supply device as claimed in claim 5, wherein the detection circuit further includes a first resistor having one end connected to the transformer and another end connected to the inverting input pin, a second resistor and a first capacitor connected in parallel between the end of the resistor connected to the inverting input pin and ground, a third resistor having one end connected to the second voltage regulating circuit and another end connected to the non-inverting pin, a fourth resistor and a second capacitor connected in parallel between the end of the resistor connected the second voltage regulating circuit and ground.

7. The power supply device as claimed in claim 6, wherein the regulated voltage generated by the transformer generates a voltage on the inverting input pin, and the regulated voltage generated by the second voltage regulating circuit generates a voltage on the non-inverting input pin; resistances of the resistors of the detection circuit and capacitances of the capacitors set to assure that the voltage generated on the non-inverting input pin is greater than the voltage generated on the inverting input pin when the voltage provided by the second voltage regulating circuit equals or is greater than the voltage provided by the transformer, and is less than the voltage generated on the inverting input pin when the voltage provided by the second voltage regulating circuit is less than the voltage provided by the transformer.

8. The power supply device as claimed in claim 5, wherein the switch circuit includes a voltage resource and two switches, each switch including a light emitting diode (LED) and a photo transistor, the voltage resource, the two LED, and the transistor of the detection circuit connected in series, one photo transistor connected to the PWM controller; when the transistor of the detection circuit is switched on, the two LED switched on by the voltage source and emit light to switch the photo transistors on, the PWM controller detecting that the photo transistor connected thereto is switched on and thus switching the transformer off.

9. The power supply device as claimed in claim 8, wherein the first voltage regulating circuit includes a fifth resistor and the switch circuit includes a sixth resistor, the fifth resistor having one end connected to the first input connector and another end connected to a collector of another photo transistor, and the sixth resistor having one end connected to the first input connector and an emitter of the another photo transistor; when the another photo transistor is switched on, the fifth resistor and the sixth resistor connected to each other and thereby changing resistance of the power supply device, and the POE system detecting resistance change of the power supply device through the first input connector and stopping providing the voltage to the power supply device upon detecting the resistance change.

10. The power supply device as claimed in claim 6, wherein the second voltage regulating circuit includes an adapter and a diode, the adapter connected to the second input connector, the diode having an anode connected to the adapter and a cathode connected to the output connector and the resistor of the detection circuit that is connected between the second voltage regulating circuit and the non-inverting pin.
